(19) United States
(12) Patent Application Publication
(10) Pub. No.: US 2005/0001561 A1
(43) Pub. Date: Jan. 6, 2005

(54) Lighting device

(76) Inventors: Viktor Vasilevich Sumarokov, Leningradskaja oblast (RU); Sergej Borisovich Zlotchevskij, Kaliningrad (RU)

Correspondence Address: BURNS DOANE SWECKER & MATHIS L L P, POST OFFICE BOX 1404, ALEXANDRIA, VA, 22313-1404, US

(21) Appl. No.: 10/472,087

(22) PCT Filed: Mar. 12, 2002
(86) PCT No.: PCT/SE02/00447

(30) Foreign Application Priority Data
Mar. 29, 2001 (SE) 0101118-8

(51) Int. Cl. H05B 41/16

(52) U.S. Cl. 315/266; 315/278

(57) ABSTRACT

The invention concerns an energy saving electrical system with good energy economy for the ignition, operation and extinguishing of gas-discharge lamps, such as up to four low-pressure fluorescent lamps or the equivalent, high-pressure mercury lamps and both high-pressure and low-pressure lamps of sodium type or metal halogen lamps in alternating current networks. The system comprises a rectifier (1), a capacitor (2), a power transistor (50) and a first transformer and a second transformer (T1, T2), each with several windings. The system furthermore comprises means (46) for stabilising the emission of light during changes of voltage in the supply network, and means (59, 39, 3, 46, 19, 35, 52) for limiting the current through and the voltage across the power transistor (50). Lamps that are to be used are connected to outputs of the windings (98 107), which windings are designed and connected such that they cooperate in order to operate the relevant lamp or lamps with negative and positive currents that are equal in magnitude.

### TECHNICAL FIELD

The invention concerns electrical technology, namely an energy saving electrical system for the ignition, operation and extinguishing of gas-discharge lamps such as low-pressure fluorescent lamps, high-pressure mercury lamps and both high-pressure and low-pressure lamps of sodium type or metal halogen lamps in alternating current networks.

### THE PRIOR ART

A operational circuit for a light source is known through U.S. Pat. No. 5,130,609, filed 26 Jan. 1990, published 17 Jul. 1992, which operation circuit comprises an input transformer that is connected via a rectifier bridge and a diode to a smoothing capacitor. The collector of a transistor is connected to the positive electrode of the smoothing capacitor via a potentiometer and the first winding of the transformer. The base contact of the transistor is connected to the positive electrode of the smoothing capacitor via the second winding of the transformer. The negative electrode of the smoothing capacitor is connected to the emitter of the transistor and, via a capacitor, to the first winding of the transformer. The third winding of the transformer is connected to a fluorescent lamp.

A rectified voltage from the supply network and the smoothing capacitor is delivered in this operation circuit via the potentiometer to the winding of the transformer, and passes via the second winding to the base of the transistor. Positive feedback is created in this way and the circuit is activated. Rectangular voltage pulses are created at the collector of the transistor that are transformed by the third winding of the transformer and pass to the lamp.

The current that passes through the lamp is small when the lamp does not give a light, the voltage impulses are large and ignite the lamp. The current increases, the voltage of the impulses decreases to a value that is sufficient for gas combustion in the lamp.

Disadvantages of the device are that it can only be used for lamps of low power since the current that passes through the potentiometer and that feeds the complete circuit increases when the power is increased. Power losses increase and the potentiometer becomes overheated. Furthermore, the negative voltage impulse at the lamp has a constant value that is proportional to the supply voltage and the positive voltage impulse has an alternating value that depends on the resistance of the lamp. As a result of this, the value of the negative current of the lamp is not equal to the positive current of the lamp, and the lamp gives an unstable illumination, and may become extinguished at one of its ends. In addition, the transistor has no protection against voltage overload at the instant at which the lamp is ignited, since the voltage is not limited to the value that is required to pass through the gas in the lamp if the lamp is broken, and the voltage increases and destroys the transistor.

The device also lacks a limitation of the current when the potentiometer is closed.

The device cannot be used for two or more lamps.

A lighting system is known through the UK patent application number 2 047 486, filed 12 Apr. 1979, published 26 Nov. 1980, which system comprises a supply network filter that is connected to a smoothing capacitor via a rectifier. The positive electrode of the smoothing capacitor is connected via a relay to a first winding of a transformer, via a first potentiometer and a first resistor to the base of a transistor, which is connected via the capacitor, a second resistor, a second potentiometer and a second winding of the transformer to the negative electrode of the smoothing capacitor and to the emitter of the transistor. The collector of the transistor is connected to a second output from the first winding of the transformer. A third winding of the transformer is connected to a lamp; the winding of the relay is connected to the output of a transistor amplifier. The input of the transistor amplifier is connected to a first photoresistor, the first photoresistor is connected in parallel with a second photoresistor that is illuminated by a light unit that is connected to a part of the third winding of the transformer or that is illuminated by an external light. The second resistor is connected in parallel to a third photoresistor that is illuminated by a photodiode.

In this system, the rectified supply voltage comes from the smoothing capacitor to the first winding of the transformer and passes via the first resistor and the first potentiometer to the base of the transistor. The second winding of the transformer creates a positive feedback, the system is activated and rectangular voltage pulses are created at the collector of the transistor. These impulses pass via the first winding to the third winding of the transformer and subsequently to the electrodes of the lamp. The lamp has a high inner resistance when it does not give a light, the impulses inside the lamp reach the breakthrough value, the lamp starts to light, its resistance decreases and lower voltage impulses are created in the lamp that ensure the emission of light. The potentiometer regulates the current at the base of the transistor and at the same time the intensity of light from the lamp. A first photoresistor, if external illumination is present, disconnects supply for the generator circuit via a relay and the lamp is extinguished. In the absence of external illumination, the lamp is ignited by the first photoresistor. The second and third photoresistors are connected in shunt to the first and second resistors. In this way they alter the current at the base of the transistor and regulate the intensity of illumination of the lamp depending on the external illumination by altering the voltage in the third winding.

Disadvantages of such a system are that it is not possible to use it with two or more luminescent lamps, with high-pressure lamps that have a high ignition voltage or with metal halogen lamps. Furthermore, the current in the lamp has different values for the positive and the negative amplitudes since the first half-wave of the voltage has an amplitude that is proportional to the voltage of the supply network, and the second half-wave of the voltage is equal to the operating voltage of the lamp, and these two voltages are not equal to each other. Thus the light emission of the lamp will be uneven along the length of the lamp and one of its ends will become extinguished after a period. In addition, limitation of the current strength in the transistor is lacking which, when the lamp is broken, may lead to the transistor becoming destroyed. Furthermore, protection against overheating is lacking. Furthermore, there is no voltage protection for the transistor if the lamp is not connected in the circuit.

The strength of illumination is regulated by changing the current in the base of the transistor, which leads to a lamp, which does not give a stable light, since the amplification coefficient for the base current in the transistor depends on its temperature. Use of a relay for ignition and extinguishing of the lamp is therefore unreliable since the capacity of the relay is limited by its design.

Regulation of the intensity of illumination by the first resistor is not efficient with regard to saving energy due to the large reduction in voltage (up to 300 volts) across it, and due to the reduction of the resistance of the resistor leading to power losses and overheating of the resistor.

A high-frequency power source for luminescent lamps is known through U.S. Pat. No. 4,005,335, filed 15 Jul. 1975, published 25 Jan. 1977. The device comprises a rectifying diode bridge, the two inputs of which are connected to an alternating current network and the two outputs of which are connected to electrodes of a first capacitor. The positive output of the rectifier is connected via a first winding of the transformer to the collector of a transistor and to the cathode of a first diode. The anode of the diode is connected to the negative output of the rectifier, to the emitter of the transistor, to the electrode of a second capacitor, with outputs of second, third and fourth windings of the transformer and via two luminescent lamps connected in parallel and a third capacitor with a second output at a fourth winding of the transformer, in parallel with a fourth capacitor, a second output of a second winding is connected in parallel via a fifth capacitor to the circuit that comprises a first resistor, a first potentiometer and a second diode all connected in series and connected to the base of the transistor, which is connected via a second resistor to the positive output of the rectifier and via a zener diode (a stabilitron) to a second electrode of a second capacitor and via a third diode with a second output of a third winding of the transformer. A second potentiometer is connected between the base of the transistor and the negative output of the rectifier.

When the supply voltage arrives, a direct voltage of approximately 280 V is created at the output of the rectifier that passes to the circuit of the autogenerator that is arranged with a transistor and a transformer. The second winding of the transformer creates a positive feedback. Rectangular pulses are created at a fourth winding of the transformer and pass via a third capacitor to electrodes of two lamps.

The inner resistances of the lamps are initially high, the amplitude of the impulse voltage increase and reaches a breakthrough value for two lamps. The lamps are ignited. The voltage amplitude in the lamps decreases to the operating voltage that maintains the lamps luminous. Similar processes occur for the voltage at the third winding with the exception that the voltage value is reduced by several times the transformation coefficient (approximately 100 times).

When the current in the network is switched on by this system although the lamps do not light, a negative impulse amplitude of approximately 11 volts exists, which charges via a third diode a second capacitor to a voltage of −10.3 volts. In this way, the stabilising voltage of 12.4 volts does not pass through the zener diode and the zener diode does not affect the function of the circuit. If one of the lamps has broken, the voltage in the lamps exceeds the value of the ignition voltage, the amplitude of the impulse at the collector of the transistor increases, the voltage at the second capacitor increases, and the zener diode opens when the voltage reaches 12.4 volts. In this way, the voltage at the base of the transistor decreases, the increase of the amplitude of the impulse at the collector of the transistor ceases and this ensures that the transistor is not destroyed.

A first potentiometer regulates the feedback current from a second winding to the base of the transistor which ensures alterations in the strength of illumination. A second potentiometer reduces the feedback current by short-circuiting it past the base to a general conductor. In this way, the intensity of illumination of the lamps is also regulated. An overall regulation of the intensity of illumination of ±40% is possible.

Disadvantages of this high-frequency power source are that it is not possible to use it for four luminescent lamps, for high-pressure lamps or for metal halogen lamps whose value of ignition voltage reaches 4 kilovolts. Furthermore, the alternating current in the lamp has different positive and negative amplitudes since the first half-wave of the voltage impulse in the lamp has an amplitude that is proportional to the voltage in the network and this is constant. The second half-wave of the voltage is equal to the operating voltage of the lamp and these voltages are not equal. Thus the rectified part of the current in the lamp passes only in one direction, the lamp gives an unevenly light along the length of the lamp, and one of the ends of the lamp becomes extinguished after a period.

Protection of the transistor against uncontrolled increase of the current that passes through it is also lacking in this system. Regulation of the intensity of the illumination takes place by changing the base current of the transistor, which leads to the lamp not providing stable illumination since the amplification coefficient for the base current of a transistor depends directly on its heating temperature.

Furthermore, the transistor in the system is not protected against overheating in an extreme working environment, and it may become destroyed. Furthermore, stabilisation of the intensity of illumination of the lamp when the voltage in the supply network changes is lacking, as it is when older lamps are used. Automatic systems for the ignition and extinguishing of lamps depending on time, on external illumination and on the presence of people in the vicinity of the lamps are also lacking.

### DESCRIPTION OF THE INVENTION

The aim of the present invention is to ensure a possibility of using a system to ignite simultaneously high-pressure mercury lamps or luminescent lamps in a quantity of from one to four, or up to four low-pressure lamps of the sodium vapour type, or with a high-pressure lamp with a higher ignition voltage, or with a metal halogen lamp; to ensure a protection for the transistor against overload by current and against overheating; to ensure stabilisation of the intensity of illumination of the lamp during changes of voltage in the supply network and over time; to ensure a stable regulation of the intensity of illumination of the lamp to a higher degree and to ensure automatic ignition and extinguishing of the lamps depending on external illumination, time and the presence of people.

The above-mentioned aims are achieved with the system for ignition, operation and extinguishing of connected gas-discharge lamps, which system is intended for different types of lamp and comprises a rectifier, a capacitor, a power transistor, and a transformer with at least four windings. Characteristics for the system, according to the invention are given in the accompanying claims.

### BRIEF DESCRIPTION OF THE DRAWINGS

The system according to the invention is illustrated in the drawings, of which

FIG. 1 shows a circuit diagram for the illumination system according to the invention and

FIG. 2 shows timing diagrams.

### EMBODIMENTS OF THE INVENTION

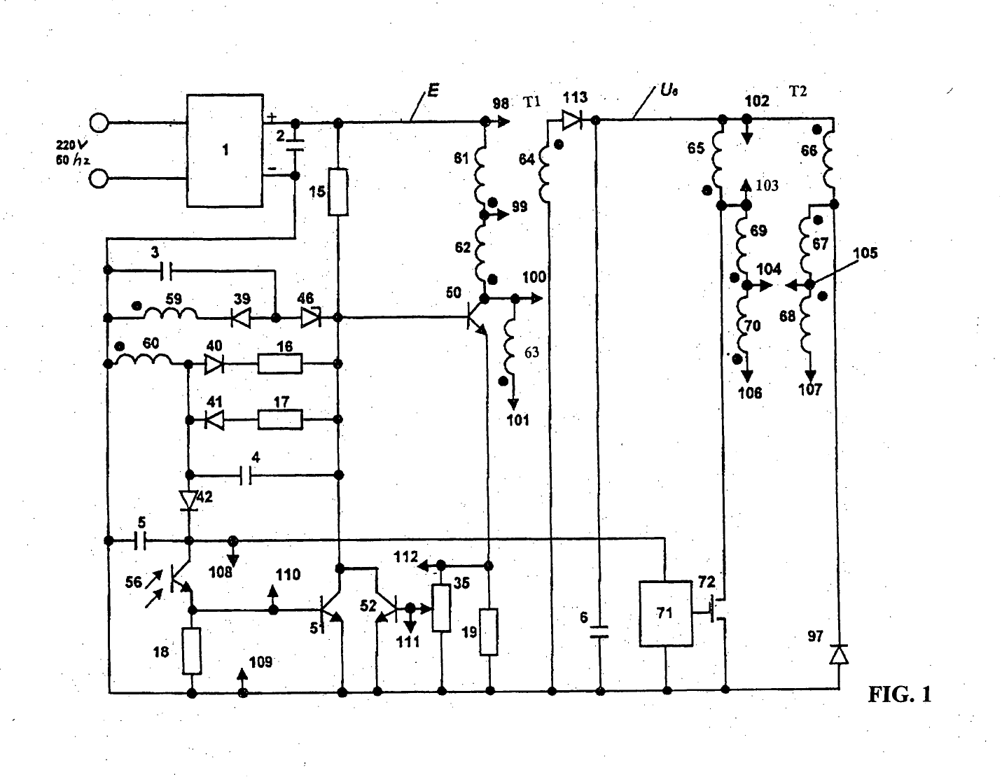

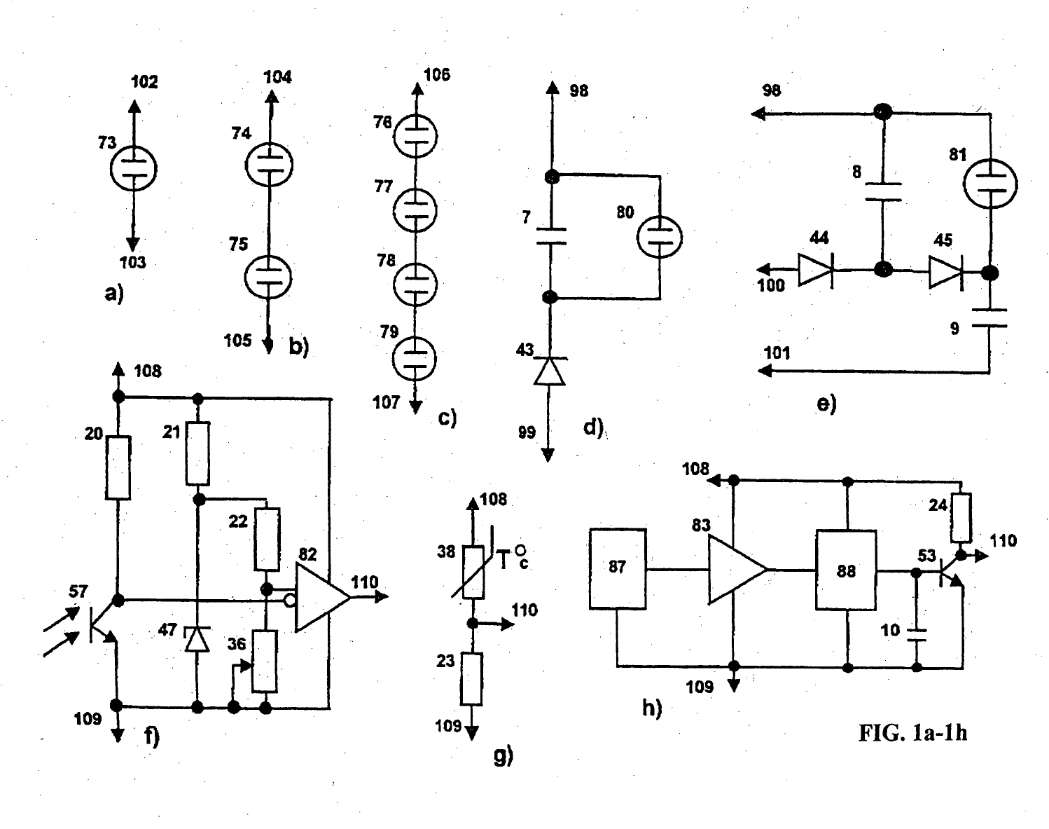

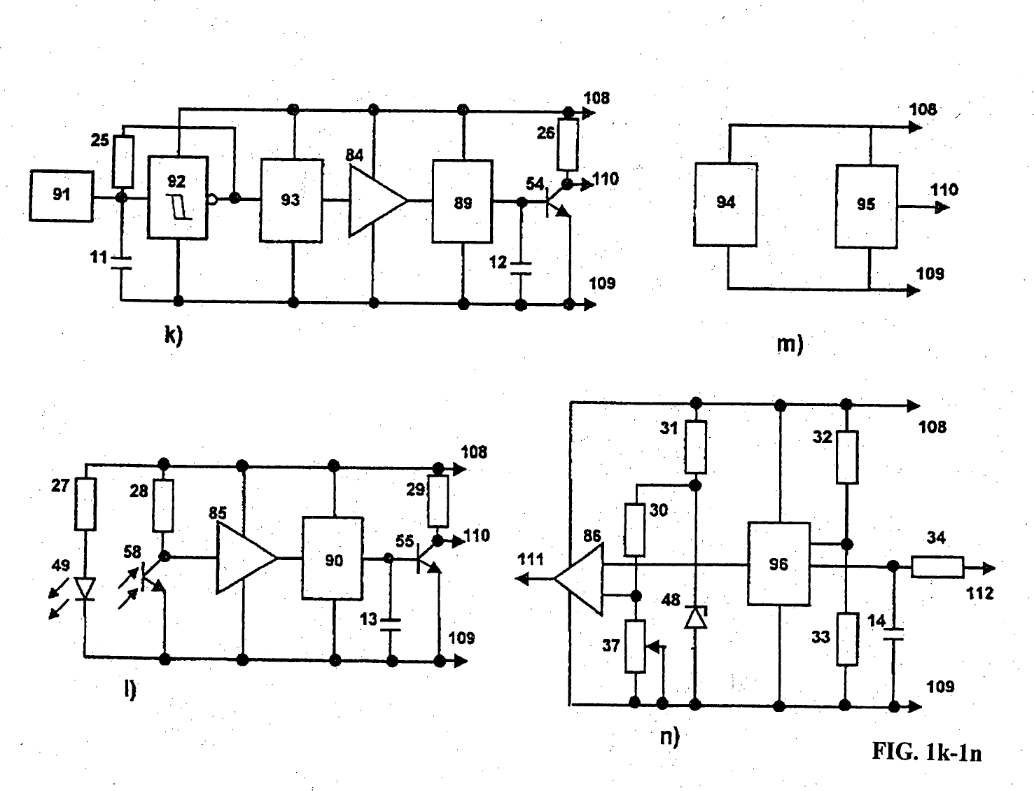

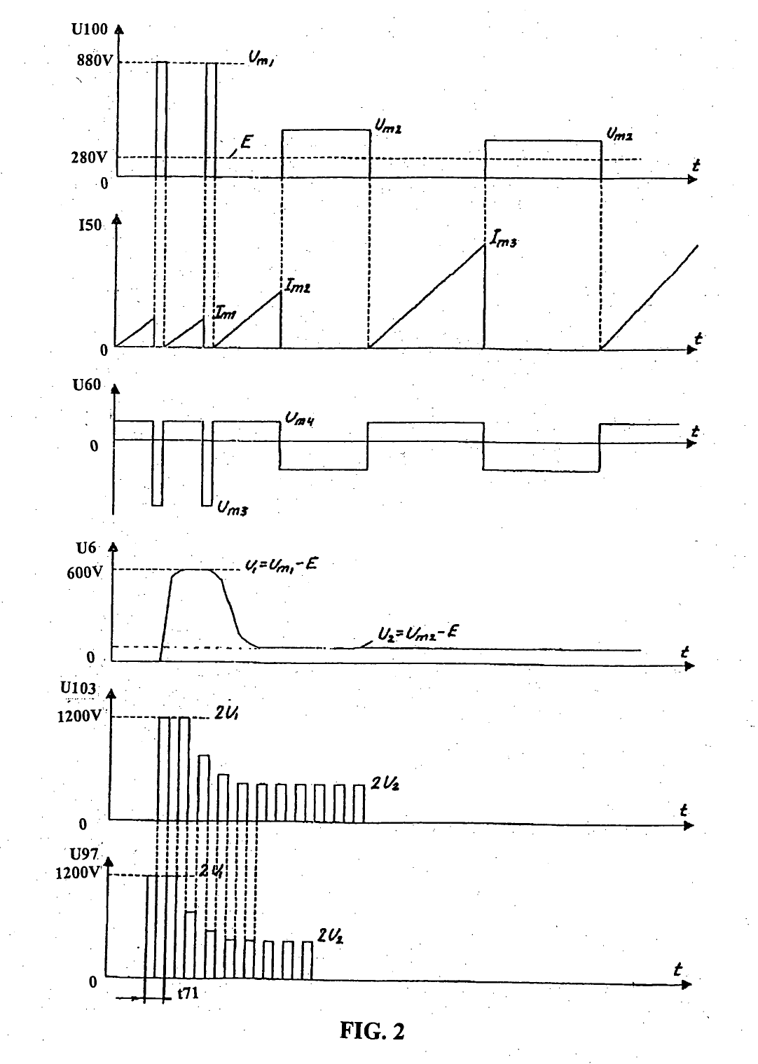

As is shown in FIG. 1, the system comprises a rectifier 1, capacitors 2-14, resistors 15-34, potentiometers 35, 36, 37, thermoresistor 38, diodes 39-45, zener diodes 46, 47, 48, light diode 49, power transistor 50, transistors 51-55, phototransistors 56, 57, 58, windings of the, first transformer 59-64, windings of the second transformer 65-70, generator 71, field effect transistor 72, lamps 73-81, amplifiers 82-86, microphone 87, amplitude detectors 88-90, capacitance electrode 91, Schmitt trigger j92, frequency detector 93, accumulator 94, timer 95, multiplier 96, diode 97, contacts at the first transformer 98-101, contacts at the second transformer 102-107, output contacts of the system 108-112, and diode 113.

The alternating supply network with a voltage of 22 volts is connected via rectifier 1 to the capacitor 2; the positive output of the rectifier is connected to the contact 98 of the winding 61 of the first transformer T1 and via the resistor 15 to the base of the power transistor 50, to the cathode of the zener diode 46, to the electrode of the resistor 16, to the electrode of the resistor 17, to the electrode of the capacitor 4, to the collectors of the transistors 51, 52. Their emitters are connected to the negative output of the rectifier 1, to contacts at the windings 59, 60 and 64, to electrodes at the capacitors 3 and 5, to the resistors 18, 35, 19, to the electrode of the capacitor 6, to the anode of the diode 97, with the general output from the generator 71, with the source electrode of the field effect transistor 72, the gate of which is connected to the output of the generator 71.

The supply output of the generator 71 is in turn connected to a second electrode of the capacitor 5, to the collector of the phototransistor 56 and to the cathode of the diode 42, the anode of which is connected to the second electrode of the capacitor 4, to the cathode of the diode 41, to the second contact of the winding 60 and to the anode of the diode 40, the cathode of which is connected to the second electrode of the resistor 16, and the anode of the diode 41 is connected to the second electrode of the resistor 17. The second contact of the winding 59 is connected to the cathode of the diode 39, the anode of which is connected to the anode of zener diode 46 and to the second electrode of the capacitor 3. The emitter of the phototransistor 56 is connected to the second electrode of the resistor 18 and to the base of the transistor 51, and the base of the transistor 52 is connected to the regulator of the potentiometer 35, the second electrode of which is connected to the second electrode of the resistor 19 and to the emitter of the power transistor 50, the collector of which is connected to the contact 100 on the winding 63 and via winding 62 to the contact 99 on the winding 61. The winding 64 is connected with the second contact to the anode of the diode 113, the cathode of which is connected to the second electrode of the capacitor 6, to the winding 66 of the second transformer and connected via the winding 65 of the second transformer to the drain output of the field effect transistor 72, and to the windings 69 and 70 of the second transformer, which windings are connected in series. The cathode of the diode 97 is connected to the second contact of the winding 66 and via the winding 67 to the contact 105 of the winding 68. The lamp 73 is connected to contacts 102 and 103 of the winding 65.

The device functions in the following manner. The network voltage, 220 V, 50 Hz, is applied at the input of the rectifier 1. A direct voltage E of approximately 280 volts is obtained at the output of the rectifier. The capacitor 2 smoothes pulses in this voltage. The direct voltage E then is applied at feed circuits of a pulse oscillator that consists of the power transistor 50 and the transformer T1 with the windings 59-63. An initial current arrives at the base of the transistor 50 through the resistor 15, which current opens the transistor 50 and activates the oscillator. This then creates impulse oscillations with a frequency of approximately 30 Hz. When the transistor 50 is open, a positive voltage pulse Um4 of approximately 10 volts arises at the winding 60, which is present to create a positive feedback, and this voltage creates a current in the base of the transistor 50 via the diode 40 and the resistor 16. The voltage at the collector is equal to 0 V. Thus a direct voltage E is present at the windings 61 and 62, and the current through the windings 61 and 62 and through the transistor 50 increases according to the equation:
I50=(E/L)*t, where L is the inductance in the windings 61, 62.

Subsequent to the current I50 reaching the value β50*Ib, where β50 is the amplification coefficient of the transistor for the current, the transistor 50 is closed, its collector voltage U100 increases and the voltage at the winding 60, U60, decreases and becomes negative, closing the transistor 50 via the diode 41 and the resistor 17. The negative voltage in the winding 60, Um3, can reach high values. This is why the resistance of the resistor 17 is 10 times larger than the resistance of the resistor 16. Thus, only a small current emerges from the winding 60, something that contributes to saving energy. Energy is saved in the windings 61, 62 when the transistor 50 is closed:
Wi=(L*Im²)/2, where Im is the maximum value of the current I50.

A high-frequency voltage impulse Um1 is created at the collector of the transistor 50.

This must not exceed the breakthrough voltage of the transistor of approximately 1500 V. The. collector voltage Um1 of the transistor is limited to a level of 880 V with the aid of the winding 59 in order to prevent breakthrough. At Um1=880 V, a negative voltage of approximately 6.2 V is created that charges the capacitor 3 to a direct voltage of 5.6 V via the diode 39, which voltage is equal to the stabilisation voltage of the zener diode 46. When the transistor 50 again opens, the zener diode 46 transmits a part of the current from the resistor 16 and in this way reduces the base current in the transistor 50 to the value Im1, which limits is the increase of the collector impulse by the voltage Um1.

The positive voltage impulses Um4 in the winding 60 charge via the diode 42 the capacitor 5 to a constant voltage of 9.4 V, which voltage is used to feed other units of the device that must be fed with low voltage. Energy is in this way saved since the feed of these units from a source with E=280 V would require more energy in reducing resistors. The voltage at capacitor 5, U108, is sufficiently stable; it is changed proportionally with the voltage in the feed network, which normally must lie within ±10%. The power of the stable voltage is explained by the fact that the amplitudes of the alternating voltages of the same polarity at all winding 59-63 depend on the resistance in the load of the generator, and the amplitudes of the voltages of the opposite polarity are proportional to the voltage in the network that is used to charge the capacitor 5.

The number of turns in the windings 61 and 62 is equal to the number of turns in the winding 64, and thus a voltage impulse on winding 64 is created that is equal to the voltage impulses U100. The voltage impulses at winding 64 therefore charge via the diode 113 the capacitor 6 to a direct voltage: U6=Um100−E.

In this way, energy that is collected in the windings 61 and 62 is converted to energy in the capacitor 6: Wu=(×U6²*C6)/2=Wi, where ΔU6 are the voltage impulses at the capacitor, produced by capacitative discharge when no pulses Um are present, and C6 is the capacitance of the capacitor 6.

The direct voltage U108 feeds the generator 71, which is activated and creates voltage rectangular pulses on the gate of the field effect transistor 72 with a frequency of approximately 40 kHz. These impulses open and-close the transistor 72. Impulses with double amplitude U103=2U6 are created on its drain output and on the winding 65. This equality is explained by the winding 66 of the second transformer having the same number of turns as the winding 65 and being connected to the winding 65, and in this way creating impulses U97 with the opposite polarity, but, due to the diode 97, the value of voltage at the winding 66 lies between 0 and −U₁. This limits the amplitudes of the voltage impulses in the windings 65-68.

When the diode 97 is open, capacitor 6 charges with the aid of the return current with all of the excess energy in the windings of the second transformer, which leads to a significant saving effect for the complete device.

The value of the voltage U6 depends on the condition of the luminescent lamp 73, of the type Polylux XL. During the instant of starting when the lamp does. not give a light and the current through it is equal to zero, the winding 65 acts with no load, the energy in the capacitor 6 is not consumed and the voltage U6 will be equal to 600 V. This value is limited by the incorporation into the circuit of the zener diode 46. The impulse. amplitude at the drain output of the field effect transistor 72 and to the common wire, respectively, does not exceed 1200 V, which is lower that the value of the breakthrough voltage of the field effect transistor 72, which is 1500 V. Thus the amplitude of the alternating voltage impulses at the winding 65 will be 600 V since the number of turns in the coil 69 is half that of the number of turns in the winding 65, and alternating voltage impulses with an amplitude of 900 V are created at the contact 103. The luminescent lamp 73, which is connected to the contacts 102 and 104, is ignited by such a voltage, even without any warn-up circuits. The current through the lamp increases, the capacitor 6 is rapidly discharged, and the voltage U6 decreases to the value 100 V. In this way, an alternating impulse voltage is created between the contacts 102 and 104 with an amplitude of 150 V, which is equal to the operating voltage of the lamp. The alternating amplitudes of the lamp are symmetrical, which is why the lamp does not become extinguished at one of its ends.

The light of the lamp depends on the current that passes through it and this current in turn depends on the energy Wi that is emitted by the windings 61 and 62. This energy depends on the maximum current Im in the transistor 50. This current arrives at the resistor 19 that has a resistance of 1 Ω, whereby a triangle-shaped voltage that depends on conductance is created. This voltage arrives at the potentiometer 35 and passes from its regulator at a reduced scale to the base of the transistor 52. The transistor opens when the base voltage exceeds 0.6 V and begins to allow all the current from the resistor 16 to pass through. The base current in the power transistor 50 will become 0, the increase in current in the power transistor 50 ceases and it is switched off. The value of the current Im, can be changed within wide limits by regulation of the regulator of the potentiometer 35, and the intensity of illumination of the lamp 73 can be changed as a result of this. The intensity of illumination at the lamp is stable such that the current in the power transistor 50 can be regulated independently of its properties. The limit of regulation of the intensity of illumination from a nominal value to lower values and changes in the power consumed by the device are ensured to more that 20 dB.

Feedback from the resistor 19 via the transistor 52 to the base of the power transistor 50 also functions as a current-limiter for the transistor 50. If the current in the transistor 50 starts to increase in an uncontrolled manner for any reason, in particular when the network supply current is switched on, or if the lamp 73 is broken, the current will be limited by this circuit at the level that depends on the state of the position of the regulator of the potentiometer 35 and the transistor 50 retains its ability to function.

The device according to FIG. 1b can function with two luminescent lamps 74, 75 (low-pressure lamps of the sodium type SOX E) connected in serial between the contacts 104 and 105. In this way, as has already been mentioned, the voltages at the contacts are equal in amplitude and of opposite phase, which is why the difference between the two voltages during start-up is 1800 V, which leads to a rapid ignition of the lamps, and during combustion of gas the alternating voltage at the lamps has an amplitude of 300 V. The alternating current is symmetrical and the lamps are evenly illuminated along their complete length.

The device according to FIG. 1c can function with four luminescent lamps 76-79 connected in series between the contacts 106 and 107. Since the number of turns in the windings 69, 70 when taken together is twice that of the number of turns in the winding 65, and the relationships in the windings 68, 67, 66 are the same, an alternating voltage is created during start-up at the contact 106 with an amplitude of 1800 V and a voltage of similar amplitude with opposite phase at the contact 107. Thus the voltage in the lamps has a magnitude of 3600 V, which leads to rapid ignition of the lamps. During the combustion period an alternating voltage is present in the lamps with an amplitude of 600 V.

It is not specified for the known system according to U.S. Pat. No. 4,005, 335 how large the consumed power is when two lamps are connected. It is, therefore, impossible to compare the device according to the invention with this known system from the point of view of energy saving. However, it is possible to compare the present system with the traditional circuit for a luminescent lamp of 40 Wh connected via a choke coil to an alternating current network.

The traditional circuit consumes 57 Wh. The present invention with one lamp and with the same intensity of illumination as the traditional circuit consumes 35 Wh. The device consumes 70 Wh when two lamps are used, 140 Wh when four lamps are used. If one calculates the saving for one lamp, a saving of energy of an average of 32% is obtained.

High-pressure mercury lamps of the type Kolorflux with a higher power can be connected to the system instead of the low-pressure fluorescent lamps according to FIGS. 1a, 1b and 1c. The difference will be that the Kolorflux lamps have a lower ignition voltage and that the voltage U6 will be significantly lower when current is connected than its maximum value of 600 V.

Lamps of the Kolorflux type, which are used for street lighting, can be connected according to FIG. 1d. The lamp is fed with direct voltage, something that is important for external illumination lamps in order to avoid the creation of electromagnetic disturbances with a frequency of 40 Hz along the streets. In this case the voltage impulses from the winding 61 will arrive at the capacitor 7 via the diode 43 and charge it up to the voltage:
U7=(Um1−E)/2≈300 V.

This direct voltage ignites the lamp 80, the voltage in the lamp subsequently decreases to 160 V and the voltage impulses at the collector of the transistor 50 become 600 V. In this case the part of the circuit containing the winding 64, the diode 113, the capacitor 6, the generator 71, the field effect transistor 72, the second transformer T2 with the windings 65-70 and the diode 97 is not needed.

The system can function according to FIG. 1e with high-pressure sodium lamps of the Lucalox type, or with a metal halogen lamp of the type Kolorarc, Multi-Vapour or Sportlight, that have a high ignition voltage of approximately 4 kV and a low combustion voltage of approximately 90 V. In this case, voltage impulses Um1=1300 V are to be created at the collector of the transistor 50. The zener diode 46 must have a stabilisation voltage of 12.6 V for this. Thus it is appropriate that the number of turns in the winding 63 is twice the number of turns in the windings 61 and 62 taken together. Voltage impulses Um1 charge the capacitor 8 and the contact 98 to a positive voltage U8=Um1−E=1020 V via the diode 44. When the transistor 50 is open the capacitor 9 is charged via the diode 45 to a voltage U9=U8+3*E=1860 V. When the transistor 50 is closed, the voltage at the contact 101 reaches a value of U101=(Um1−E)*3+E=3340 V.

In this case a voltage U81=U101+UC9 5200 V is created in the lamp 81. This voltage ignites the lamp 81 at the first attempt, (both when cold and when warm). A direct voltage that is approximately 90 V will arrive at the lamp after ignition from the capacitor 8 via the diode 45. The capacitor 9 influences the action of the circuit to a small degree since its capacitance is very much smaller than the capacitance of the capacitor 8. The amplitude of the voltage impulses at the collector of the transistor 50 is thus Um2 E+90 V=370 V. The capacitor 8 is regularly charged via the diode 44 by this impulse.

Circuits are arranged in the system for the control of the intensity of illumination for lamps of all types. The phototransistor 56 is used, placed where there is external illumination and where the light from the lamp does not reach. In the absence of external illumination there is no current in the phototransistor, the transistor 51 is closed and does not influence the action of the system, the lamp gives a light within its nominal region. If external illumination is present, the current passes through the phototransistor 56 and arrives at the base of the transistor 51, the transistor 51 opens and reduces the base currents in the transistor 50, and this leads to a reduction of the current Im and an equivalent reduction of the intensity of illumination of the lamp. If the external illumination is bright, the lamp does not give light at all. The lamp is reignited if the external illumination disappears. The action of the lamp can be automatically regulated in this way such that the lamp does not give a light during the daytime, gives a light at a reduced power during dusk and gives a light in its nominal region at nighttime. A great deal of energy is saved due to such a rational illumination.

A phototransistor 57 is mounted on the surface of the lamp according to FIG. 1f. The lamp will be caused to give a stable light in this way. In this case, the current in the phototransistor depends only on the light of the lamp, and the voltage at its collector will be inversely proportional to the intensity of illumination of the lamp. This voltage is applied to the inverse input of the amplifier 82. Part of the voltage from the zener diode 47 is applies to the second input of the amplifier 82. The level of this voltage depends on the potentiometer 36. The output voltage from the amplifier 82 is applied to the base of transistor 51. If the intensity of illumination of the lamp increases by an unreasonable amount, the voltage at the collector of the phototransistor 57 will decrease, the voltage at the output of the amplifier increases, the base current in the transistor 51 increases and it opens further and decreases the intensity of illumination of the lamp. The circuit functions such that the voltages at the inputs to the amplifier are always equal and stable. Thus the light emitted by the lamp is also stable. The intensity of the light is regulated with the aid of the potentiometer 36 by changing the voltage across the divider with the resistors 22 and 36, the voltage at the collector of the phototransistor 57 is changed and the intensity of illumination of the lamp is changed. Thus the intensity of illumination of the lamp does not depend on oscillations in the electrical supply network or of the age of the lamp, and in this way the lifetime of the lamp is increased. Considerably more energy is also saved since the intensity of illumination of the lamp does not increase above normal even if the voltage in the electrical supply network increases. The energy that would be needed for such an increase is not consumed and this does not shorten the lifetime of the lamp, which may otherwise happen.

A thermoresistor 38 is mounted according to FIG. 1g onto the power transistor 50 or the field effect transistor 72. If the particular transistor becomes overheated, the magnitude of the thermoresistance decreases very dramatically, the current that passes, through the thermoresistor increases and arrives at the base of the transistor 51,: which opens and decreases the value of the current Im. In this case, the intensity of illumination of the lamp decreases, the energy consumed decreases, heating of the relevant transistor decreases, and the transistor is protected from heat breakdown.

The system can also handle automatic ignition and/or extinguishing of a lamp depending on the presence of people close to the lamp. This is necessary, for example, for the illumination of indoor staircases, corridors in hotels and entrances to houses and garages.

A microphone 87 is connected according to FIG. 1h to the base of a transistor 53 via an amplifier 83 and an amplitude detector 88. If a person passes by, the microphone 87 records the noise of steps, the amplifier 83 amplifies the signals and converts them to voltage impulses at the output of the amplitude detector 88. The pulses are integrated in the capacitor 10 and direct voltage arrives at the base of the transistor 53, the voltage at the collector of which decreases to 0. The transistor 53 is closed and the lamp starts to light. After the person has passed by, the capacitor 10 remains charged for a period and the lamp continues to light. The capacitor 10 subsequently discharges, the transistor 53 closes and the transistor 51 opens with the current that passes via the resistor 24, and the lamp is extinguished.

A Schmitt trigger is activated according to FIG. 1k as a generator at a high frequency, due to the feedback in the form of the resistor 25 and the capacitor 11. The frequency of the signal of the generator depends on the magnitude of the capacitance in the capacitor 11. If a person is present moving in the vicinity, the capacitance contact 91, which is placed externally to the system, alters the capacitance relative to the common wire. The frequency of the generator is changed as a result of the person's movements. The frequency detector 93 converts the changes in frequency to change in the output voltage, which is amplified by the amplifier 84 and emerges at the output of the amplitude detector 89 as constant pulses. The capacitor 12 integrates these pulses and ignites the lamp via the transistor 54. After the passage of a person, the frequency of the generator becomes constant, a direct voltage is applied to the output of the frequency detector, the signal decreases to 0 at the output of the amplitude detector and the lamp becomes extinguished within a certain period.

An infrared power light emitting diode 49 illuminates according to FIG. 1l the surrounding space. The light is reflected by objects and arrives at the input to an infrared phototransistor 58. If a person moves in the vicinity, the reflected light is changed in co-ordination with the movements of the person. The current in the phototransistor 58 is changed, the alternating signal at the input to amplifier 85 is strengthened and converted to pulses at the output of the amplitude detector 90, the capacitor 13 is charged, opens transistor 55 and ignites the lamp. After the person has passed, the reflected light from the diode 49 will become constant, the voltage at the output of the amplitude detector decreases to 0, and the lamp is extinguished.

An accumulator 94 is charged according to FIG. 1m via the diode 42 and a timer 95, that is a clock with an annual calendar in which information concerning the start and end of all nights throughout the year is available. Thus the timer sends a 0-signal to the base of the resistor 51 every night in order to ignite the lamp. The timer creates a constant signal at its output that opens the transistor 51 during each day, and the lamp does not give a light.

Use of the system according to FIGS. 1h, 1k and 1l allows the possibility of saving energy to a degree exceeding 50%, since the lamps are ignited only when persons are present and are in practice always extinguished during the night.

It is no longer necessary to use mechanical switches, which extends the lifetime of the lamps and increases the level of comfort for the users. Use of the device with the phototransistor 56 and according to FIG. 1m allows the possibility of connecting the lamps for outdoor illumination to an ordinary electrical supply network that is never switched off.

The need of laying down a special supply network disappears, which leads to considerable savings.

It must be pointed out that all systems automatically connect the power transistor 50 via the transistor 51 in order to prevent their output current from exceeding:
Ia≦Im/(β50*β51);≈10⁻³-Im

This current is small since little energy is consumed and low-power sensors can be used. The use of phototransistors ensures a greater sensitivity for the emitted light than the use of photoresistors and photodiodes.

The system according to FIG. 1n allows the possibility of stabilising the power consumed from the supply network during changes in :voltage within 220 V ±60 V. The power that is consumed by the system passes to a large degree through the power transistor 50. The value of this power is:
T₀
P=E(1/To)*∫I₅₀dt=E*I_{50cp},
where T₀ is the period of oscillations of impulses, at the collector of the power transistor 50;
I₅₀ is the current in power transistor 50; and
I_{50cp} is the mean current in the power transistor 50.

The current in the power transistor 50 arrives in the form of voltage at the resistor 19 and has a triangle form. The resistor 34 and the capacitor 14 integrate this signal and a voltage that is proportional to I_{50cp} is applied to the input of the multiplier 96. The voltage U108 at the cathode of the diode 42 is proportional to the voltage E or the voltage in the supply network. This is why a voltage is applied on the output of the multiplier 96 that is proportional to the power consumed. This voltage is compared in the amplifier 86 with the stable voltage that is applied with the aid of the potentiometer 37 onto the second input of the amplifier. These voltages are equal.

The output signal from the amplifier 86 controls the transistor 52 and regulates the intensity of illumination of the lamp and, consequently, regulates the level of the power consumed. The regulation of the potentiometer 37 changes the voltage at this resistor and this means that the level of the power consumed and therefore the intensity of illumination of the lamp can be changed. The intensity of illumination of the lamp will be stable during changes in voltage in the supply network within ±30%. Hence the system will be an excellent source for alternating current and direct current that maintain a constant power at the lamp that is determined by the potentiometer 37, independent of oscillations in the supply network and the age of the lamp.

Such a property of the device is particularly important for sodium vapour lamps of high-pressure type, such as Lucalox. These lamps are very sensitive to overconsumption of the power consumed. When the voltage in the supply network increases, the lamp becomes overheated; consumption of mercury increases and the lamp looses illumination capacity an is rapidly destroyed. This property is present if the lamp is supplied according to the traditional circuit via a choke coil. Furthermore, as the lamp becomes older, its internal resistance increases, the current that passes through the lamp decreases and the choke coil connection does not ensure the stable functioning of the lamp, such that the luminous lamp, becomes extinguished, cools, is re-ignited, and so on. Many ignition and extinguishing attempts destroy the electrodes of the lamp and the lamp becomes black.

The device according to the invention can rapidly, at the first attempt, ignite the lamp and maintain undestroyed electrodes. The stable power consumption of the lamp reduces its overheating, reduces the consumption of mercury and as a consequence of this extends the lifetime of the lamp. The device ensures the stable illumination effect of the lamp when the internal resistance of the lamp rises as time passes, the voltage drop across the lamp consequently increases, which only improves the function of the device and eliminates flickering of the lamp, something that also extends the lifetime of the lamp. There is no need to install an expensive mercury dosage unit in the lamp.

If the lamps are supplied via a choke coil, they have twice the difference in the intensity of illumination. When the device according to the invention is used, the lamps consume a constant power and all the lamps used have the same level of the intensity of illumination as a consequence of this.

To summarise: the device according to the invention has many advantages over known systems. It is namely possible to simultaneously connect one, two or four luminescent lamps and to ensure their even and stable intensity of illumination along the complete length of the lamps. It is possible simultaneously to connect mercury lamps with high pressure in a quantity from one to four, one or two sodium vapour lamps of high-pressure type or of low-pressure type, or one or two metal halogen lamps. Protection for the power transistor is ensured not only against voltage but also against current and against overheating, something that significantly increases the safety of the system. The scale for the manual regulation of the intensity of illumination of the lamps is extended by a factor of five, the stability of illumination of the lamps following the regulation process is increased.

A high stability of the intensity of illumination of the lamps when the voltage in the supply network changes within ±30% is achieved, and the lamps maintain a stable emission of light even if they become older. A stabilisation of the power consumed by the lamps is achieved, something that is particularly important when the network supply voltage is increased. As a result of this, an increase in the lifetimes of the lamps is ensured, that is, the lamps do not burn out as. a result of overloading.

Automatic ignition and extinguishing of street lamps is ensured by three different methods depending on the external illumination or the time of day, something that saves energy up to a level of 20%.

Automatic ignition and extinguishing of security lamps is ensured by three different methods depending on the presence of persons, something that saves energy up to a level of 50%. The large saving arises due to the fact that it is not necessary to build up a special supply network that can be disconnected for street lamps that have their own disconnection circuits. The device for which a patent is applied saves an average of up to 30% electrical energy for street lamps compared with an equivalent solution using choke coils.

Use of the device for which a patent is applied for the supply of high-voltage lamps of sodium vapour type or of metal halogen type ensures a rapid ignition of the lamps with a high direct voltage, and operation with a low direct voltage within the nominal region of operation, something that ensures that there are no disturbances in the electromagnetic field that contaminate the environment.

Different models of the system assembled according to the system according to the invention function well for different types of lamp with powers from 40 to 250 Wh. There are, however, no difficulties in increasing the power of the lamps used up to 1 kWh.

The saving of electricity when using this device also arises due to the fact that all lamps have been made in practice for a supply network of 220±10% V. The lamps are to function within the nominal region at the lowest value of the supply voltage, 198 V. At a voltage of 220 V and higher in the network, the lamps function with an excess over the nominal intensity of illumination and consume more electrical energy (approximately 10-20%). The present system stabilises the power consumed with a precision of 1% when there are changes in the supply network of 220 V±30% V. If the device is adjusted such that the intensity of illumination is equivalent to the intensity of the strength of illumination of the lamps that are supplied by conventional systems at a voltage of 198 V, the saving can be up to 20% at the same intensity of illumination.

Many elements in the system, including the elements that function automatically, can be made as a microcircuit which ensures a high security of the device with small dimensions.

The present system can be used for the illumination of premises, streets and in order to create emergency lighting in locations where such are necessary. Its use ensures new variations of the use of illumination equipment, increases comfort when in use, increases safety of the lamps that are used, extends the lifetimes of the lamps, ensures a significant saving with respect to electricity consumption and can give a major economic gain.

References

1. U.S. Pat. No. 5,130,609, filed 26 Jan. 1990, published 17 Jul. 1992.
2. Patent UK, application number 2 047 486, filed 12 Apr. 1979, published 26 Nov. 1980.
3. U.S. Pat. No. 4,005,335, filed 15 Jul. 1975, published 25 Jan. 1977.

1. A energy saving system for the ignition, operation and extinguishing of connected gas-discharge lamps which system is connected to the alternating current supply network via a rectifier (1), a capacitor (2), a power transistor (50) and a first transformer (T1) with at least four windings (59-63), which said units are not only part of an ignition circuit for the rapid ignition of the lamps with a high direct voltage, but also part of an oscillator circuit for operation of the lamps at a lower voltage and part of a direct voltage circuit with a lower voltage for the operation of the components that are included in the system, characterised in that the system furthermore comprises
means (64, 113, 6, T2, 71, 72, 97), comprising a second transformer (T2) with at least six windings, for the connection and simultaneous ignition of 1-4 luminescent lamps (73-79) or the equivalent, and with a pulse generator (71) and a field effect transistor (72) for the operation of the second transformer (T2),
means (61, 43, 7) for the connection of a high-pressure mercury lamp (80) or the equivalent that is supplied with direct current and that has a low ignition voltage and high power; and
means (61, 62, 63, 44, 45, 8, 9) for the connection of a high-pressure sodium vapour lamp or metal halogen lamp (81) or the equivalent with an ignition voltage of approximately 4 kV and low operational voltage,
means (46) connected to the base of the power transistor (50), in order to stabilise the emission of light from the lamp or lamps when the supply networks voltage changes,
means (59, 39, 3, 46, 19, 35, 52) to limit the current and the voltage through the power transistor (50),
whereby the electrodes of the lamp or lamps (73-81) are connected to outputs (98-101) of the windings (61-63) of the first transformer (T1) or outputs (102-107) of windings (65-70) of the second transformer (T2) which windings are mutually connected and designed such that they cooperate in order to operate the relevant connected lamp with a negative current amplitude that has the same magnitude as the positive current amplitude and to supply the relevant lamp or lamps with the ignition and operational voltages required.

2. The system according to claim 1, characterised in that it comprises a phototransistor (56) or equivalent element in order to influence the current to the base of the power transistor (50) depending on the incident light and in this way automatically control the ignition, operation and extinguishing of the relevant lamp or lamps.

3. The system according to any one of claim 1, whereby the inputs of the rectifier (1) in the system are connected to the alternating current supply network, and the outputs of the rectifier (1) are connected to electrodes of the capacitor (2), whereby the positive output of the rectifier is connected to a contact (98) of a first winding (61) of the first transformer (T1), and is connected via a first resistor (15) to electrodes of second (16) and third (17) resistors and to the electrode of a second capacitor (4), which is together with the second electrode connected to the anode of a first diode (40) and to the contact of the second winding (60) of the transformer (T1), whereby the cathode of the first diode (40) is connected to the second electrode of the second resistor (16), and whereby a second contact of the second winding (60) of the transformer (T1) is connected to the negative output of the rectifier, to contacts on third (59) and fourth (64) windings of the transformer (T1), to an electrode of a potentiometer (35), to an electrode of a third capacitor (6), to an electrode of a fourth resistor (19) and via a fourth capacitor (3) to the anode of a zener diode (46), characterised in that the system comprises fifth (62) and sixth (63) windings of the transformer (T1), a phototransistor (56), a pulse generator (71), a field effect transistor (72), together with a second transformer (T2) with six windings (65-70), whereby the second resistor (16) is connected to the base of the power transistor (50), to the cathode of the zener diode (46), to the collectors of first and second transistors (51, 52); and that the second electrode of the third resistor (17) is connected to the anode of a second diode (41) whereby its cathode is connected to the anode of the first diode (40), to the second contact of the second winding (60) of the first transformer (T1), to the anode of a third diode (42), the cathode of which is connected to the electrode of a fifth capacitor (5), to the feed output of the generator (71), to the collector of the phototransistor (56), the emitter of which is connected to the base of the first transistor (51) and via a fifth resistor (18) to the emitters of the first and second transistors (51, 52), to the second electrode of the fifth capacitor (5), to a common output of the generator (71), to the source of the field effect transistor (72), to the anode of a fourth diode (97) and to the negative output of the rectifier (1), and that the second contact of the third winding (59) of the first transformer (T1) is connected to the cathode of a fifth diode (39) whereby its anode is connected to the anode of the zener diode (46); and that the emitter of the power transistor (50) is connected to the second electrodes of the fourth resistor (19) and the potentiometer (35), the regulator of which is connected to the base of the second transistor (52), and that the output of the generator (71) is connected to the gate of the field effect transistor (72), the drain of which is connected via the first winding (65) of the second transformer (T2), to the second electrode of the third capacitor (6), to the cathode of a sixth diode (113), the anode of which is connected to the second contact of the fourth winding (64) of the first transformer (T1), the first winding (61) of which is connected with its second contact via a fifth winding (62) to the contact of a sixth winding (63) and to the collector of the power transistor (50); and that the second transformer (T2) is connected with the contact of the second winding (66) to the cathode of the sixth diode (113), and the second contact of the second winding (66) is connected to the cathode of the fourth diode (97) and to third (67) and fourth (68) windings connected in series, and that the output of the field effect transistor (72) is connected via the fifth winding (69) to the contact of the sixth winding (70).

4. The system according to claim 3, characterised in that two lamps (74, 75) connected in series are connected between a common contact (105) to third (67) and fourth (68) windings of the second transformer (T2) on the one side, and between a common contact (104) to fifth (69) and sixth (70) windings of the second transformer (T2) on the other side.

5. The system according to claim 3, characterised in that the second contact (107) of the fourth winding (68) of the second transformer (T2) is connected via four lamps (76-79) connected in series to the second contact (106) of the sixth winding (70) of the second transformer.

6. The system according to claim 3, characterised in that the common contact (99) of first (61) and fifth (62) windings of the first transformer (T1) is connected to the anode of a diode (43) and that its cathode is connected via capacitor (7) and lamp (80) connected in parallel to the positive output (98) of the rectifier.

7. The system according to claim 3, characterised in that the collector (100) of the power transistor (50) is connected to the anode of a diode (44), the cathode of which is connected via a capacitor (8) to the positive output (98) of the rectifier and via a lamp (81) to the cathode of a second diode (45) and via a capacitor (9) to the second contact (101) of the sixth winding (63) of the first transformer (T1) and that the anode of the last-mentioned diode (45) is connected to the cathode of the first-mentioned diode (44).

8. The system according to claim 3, characterised in that the emitter (109) of a phototransistor (57) is connected to the anode of a second zener diode (47), to the electrode and the regulator of a potentiometer (36), to the common output of an amplifier (82), and to the negative output (109) of the rectifier, and that the collector of the phototransistor (57) is connected to the inverse input of the amplifier (82) and via a resistor (20) to the electrode of a further resistor (21), to the supply contact of the amplifier (82) and to the cathode (108) of the third diode, and that the direct input of the amplifier (82) is connected to the second electrode of the potentiometer (36) and to the electrode of a resistor (22), the second electrode of which is connected to the cathode of the second zener diode (47) and to the second electrode of the further resistor (21), and that the output (110) of the amplifier (82) is connected to the base of the first transistor (51).

9. The system according to claim 3, characterised in that the base (110) of the first transistor (51) is connected via a thermoresistor (38) to the cathode (108) of the third diode (42).

10. The system according to claim 3, characterised in that the negative output of the rectifier (109) is connected to common outputs of a microphone (87), an amplifier (83), an amplitude detector (88), to the electrode of a capacitor (10) and with the emitter of a third transistor (53), whereby the output of the microphone (87) is connected to the input of the amplifier (83), the output of which is connected to the input of the amplitude detector (88), the output of which is connected to the second electrode of the capacitor (10) and with the base of the third transistor (53), the collector (110) of which is connected to the base of the first transistor (51) and via a resistor (24) to the supply contacts of the amplitude detector (88) and the amplifier (83) and to the cathode (108) of the third diode (42).

11. The system according to claim 3, characterised in that the negative output of the rectifier (109) is connected to common outputs of a Schmitt trigger (92), a frequency detector (93), an amplifier (84), an amplitude detector (89), to the electrode of a capacitor (11), to the electrode of a further capacitor (12), to the emitter of a third transistor (54), whereby a capacitance electrode (91) is connected to the input of the Schmitt trigger (92) and via a resistor (25) to the output of the Schmitt trigger (92) and to the input of the frequency detector (89), the output of which is connected to the input of the amplifier (84), the output of which is connected to the amplitude detector (89), the output of which is, in turn, connected to the second electrode of the additional capacitor (12) and to the base of the third transistor (54), the collector of which is connected to the base (110) of the first transistor (51) and via a resistor (26) to supply outputs (109) of the amplitude detector, the amplifier, the frequency detector, the Schmitt trigger and the cathode of the third diode (42).

12. The system according to claim 3, characterised in that the negative output of the rectifier (109) is connected to common outputs of an amplifier (85) and an amplitude detector (90), to the cathode of a photodiode (49), to the electrode of a capacitor (13), to the emitter of a transistor (55) and to the emitter of a phototransistor (58), the collector of which is connected to the electrode of a further resistor (28) and to the input of the amplifier (85), the output of which is connected to the input of the amplitude detector (90), the output of which is connected to the second electrode of the capacitor (13) and to the base of the transistor (55), the collector of which is connected to the base (110) of the first transistor (51) and via a resistor (29) to supply outputs (108) of the amplitude detector (90) and the amplifier (85), to the second electrode of the additional resistor (28), to the cathode of the third diode (42) and via a resistor (27) to the anode of the light diode (49).

13. The system according to claim 3, characterised in that the negative output of the rectifier (109) is connected to a common output of a timer (95) and to the negative electrode of an accumulator (94), whereby the cathode (108) of the third diode (42) is connected to the positive electrode of the accumulator (94) and to the supply output of the timer (95), the output of which is connected to the base (110) of the first transistor.

14. The system according to claim 3, characterised in that the regulator of a potentiometer (37) is connected to the anode of a second zener diode (48), to negative supply outputs of an amplifier (86) and a multiplier (96), to the negative output (109) of the rectifier and to one electrode of a capacitor (14), the second electrode of which is connected to the input of the multiplier (96) and via a resistor (34) to the emitter (112) of the power transistor (50), whereby the second input of the multiplier (96) is connected via a resistor (32) with positive supply outputs of the multiplier (96) and the amplifier (86), with the output (108) of the cathode of the third diode (42), and via a resistor (31) both to the cathode of the second zener diode (48) and via a resistor (30) to the inverse input of the amplifier (86), the second input of which is connected to the output of the multiplier (96), and whereby the output (111) of the amplifier is connected to the base of the second transistor (52).

15. The system according to any one of claim 2, whereby the inputs of the rectifier (1) in the system are connected to the alternating current supply network, and the outputs of the rectifier (1) are connected to electrodes of the capacitor (2), whereby the positive output of the rectifier is connected to a contact (98) of a first winding (61) of the first transformer (T1), and is connected via a first resistor (15) to electrodes of second (16) and third (17) resistors and to the electrode of a second capacitor (4), which is together with the second electrode connected to the anode of a first diode (40) and to the contact of the second winding (60) of the transformer (T1), whereby the cathode of the first diode (40) is connected to the second electrode of the second resistor (16), and whereby a second contact of the second winding (60) of the transformer (T1) is connected to the negative output of the rectifier, to contacts on third (59) and fourth (64) windings of the transformer (T1), to an electrode of a potentiometer (35), to an electrode of a third capacitor (6), to an electrode of a fourth resistor (19) and via a fourth capacitor (3) to the anode of a zener diode (46), characterised in that the system comprises fifth (62) and sixth (63) windings of the transformer (T1), a phototransistor (56), a pulse generator (71), a field effect transistor (72), together with a second transformer (12) with six windings (65-70), whereby the second resistor (16) is connected to the base of the power transistor (50), to the cathode of the zener diode (46), to the collectors of first and second transistors (51, 52); and that the second electrode of the third resistor (17) is connected to the anode of a second diode (41) whereby its cathode is connected to the anode of the first diode (40), to the second contact of the second winding (60) of the first transformer (T1), to the anode of a third diode (42), the cathode of which is connected to the electrode of a fifth capacitor (5), to the feed output of the generator (71), to the collector of the phototransistor (56), the emitter of which is connected to the base of the first transistor (51) and via a fifth resistor (18) to the emitters of the first and second transistors (51, 52), to the second electrode of the fifth capacitor (5), to a common output of the generator (71), to the source of the field effect transistor (72), to the anode of a fourth diode (97) and to the negative output of the rectifier (1), and that the second contact of the third winding (59) of the first transformer (T1) is connected to the cathode of a fifth diode (39) whereby its anode is connected to the anode of the zener diode (46); and that the emitter of the power transistor (50) is connected to the second electrodes of the fourth resistor (19) and the potentiometer (35), the regulator of which is connected to the base of the second transistor (52), and that the output of the generator (71) is connected to the gate of the field effect transistor (72), the drain of which is connected via the first winding (65) of the second transformer (T2), to the second electrode of the third capacitor (6), to the cathode of a sixth diode (113), the anode of which is connected to the second contact of the fourth winding (64) of the first transformer (T1), the first winding (61) of which is connected with its second contact via a fifth winding (62) to the contact of a sixth winding (63) and to the collector of the power transistor (50); and that the second transformer (T2) is connected with the contact of the second winding (66) to the cathode of the sixth diode (113), and the second contact of the second winding (66) is connected to the cathode of the fourth diode (97) and to third (67) and fourth (68) windings connected in series, and that the output of the field effect transistor (72) is connected via the fifth winding (69) to the contact of the sixth winding (70).
